(19) United States
(12) Patent Application Publication
(10) Pub. No.: US 2017/0046924 A1
(43) Pub. Date: Feb. 16, 2017

(54) Dynamic Interactive Electronic Gaming System

(71) Applicant: DRAGOS BURIU, CONSTATA (RO)

(72) Inventor: DRAGOS BURIU, CONSTATA (RO)

(21) Appl. No.: 15/236,808

(22) Filed: Aug. 15, 2016

Related U.S. Application Data
(60) Provisional application No. 62/204,685, filed on Aug. 13, 2015.

(51) Int. Cl. G07F 17/34; G07F 17/32

(52) U.S. Cl. CPC G07F 17/34; G07F 17/3251; G07F 17/3213; G07F 17/3209

(57) ABSTRACT

A social, dynamic gaming system of the slot-machine variety is disclosed. The gaming system is configured to provide players adaptive control over symbols on the reels, enabling players to exchange neighboring symbols via the use of a ‘base power’ after every spin, allowing the player to seemingly control the outcome of the game more directly. A ‘special power’ is introduced, allowing players to destroy an entire row of a reel, regenerate a reel, or clone a symbol on a reel during gameplay. Mini-games, bonus objectives, and boss challenges may be played by players in competitive or cooperative teams against the house to win rewards. Tournament play with multiple players provides for group payout and social integration into gameplay.

### CONTINUITY

This application is a non-provisional application of provisional patent application No. 62/204,685, filed on Aug. 13, 2015, and priority is claimed thereto.

### FIELD OF THE PRESENT INVENTION

The present invention pertains to slot machine gaming, and more specifically relates to a dynamic, interactive reward gaming system configured to enable players to interactively exchange, replace, and eliminate reward symbols on the reel(s) during a turn.

### BACKGROUND OF THE PRESENT INVENTION

Conventional slot machines have become a large part of the gambling industry nearly since their inception in the late 1800's. Countless advancements have been made in the slot machine industry, including the introduction of numerous pay lines, digitized reels, extra symbols, digital touch screens, currency detectors, spin wheels, extra bonus games, and modern computerization of payouts and probability enforcement. The integration of computers into slot machines has created numerous variations on the nature of gameplay, and how rewards are administered. Today, slot machines rank as the most popular method of gambling in casinos worldwide. While some players still enjoy the physical nature of physical reels and even still employ the side-mounted lever occasionally, many players have jumped on-board with the newest digital gaming systems, and elect to exclusively play on machines equipped with a digital display screen.

With the introduction of touch screens, players are now able to interact directly with the screen, providing for mini games and bonus games to arise in the industry. Players may touch the screen to learn about the rules of the game, to select bonus tiles during mini-games, to touch cards to select them for play, and other touch-based aspects of modern slot machine gameplay that facilitate an easy-to-use, multisensory experience.

Many mini-games have been introduced to the slot gaming industry to capitalize on this advancement in technology. Interactivity beyond the basic ‘Spin’ and ‘Bet’ buttons has emerged, making way for a wide realm of gaming possibilities. Unfortunately, much of the interactivity of the digital slot machines of the industry is limited to extraneous mini-games that are played outside of normal gameplay, or to spin-wheels and progressive bonuses configured to entice players to continue playing for tong periods of time. Few gaming companies have made widespread use of the touch screen component of modern slot machines a prominently used portion of gameplay. There is a need for more interactive elements in modern slot machine gameplay in order to make the experience more enjoyable, and to seemingly provide the player with more control over the outcome of the game.

Some slot machine gaming systems have been introduced that are equipped with partially sliding reels that are capable of advancing or retracting one position on reels. Games such as Double Diamond, a reel gaming machine equipped with diamond symbols. Special diamond symbols (oriented facing upwards or downwards) are configured to move after the initial spin has completed. The direction the symbols advance on the reel is determined by the orientation of the diamond. Therefore, in some cases, the diamond may move towards the pay line, increasing the chance for a payout, and in other cases, the diamond will move away from the pay line.

While this gaming concept has grown in popularity over the years, the interactivity of the game is limited. Similarly, only the specialty indicated diamond symbols may move, and the movement of the symbols is automated. If there were a game in which any symbol could be moved one position or exchanged with a different symbol on the reel in any direction, additional control can be given to the player, seemingly increasing the player's chances of winning, and additional interactivity during gameplay can be achieved.

Thus, there is a need for a new slot machine game and system configured to provide the player with more control over gameplay with dynamic, interactive elements that are designed to keep the player engaged, happy, and entertained. Such a system would preferably employ additional challenges, mini-games, and a bonus wheel, incorporating multi-faceted elements into standard gameplay.

### SUMMARY OF THE PRESENT INVENTION

The present invention generally comprises a reward gaming machine system in the vein of conventional slot machines. Rather than solely employing static symbols on rotating reels, the present invention includes the implementation of dynamic symbols that may change position and/or status according to the will of the player. Additionally, a series of mini-games are employed, along with a ‘Lucky Wheel’ to ensure that the game itself remains dynamic, helping to keep the player entertained and engaged with the game.

Likewise, special powers, Boss Challenges, and Bonus Objectives are employed to add a twist of perceived skill to the industry. Rather than using simple, non-interactive gaming systems equipped with little more than a ‘Bet’ button and a ‘Spin’ button, the present invention employs the use of a touch screen display to fully immerse the player into a multitude of games that require timely user input and interaction to continue. Mini-games and Boss Challenges are configured to be presented to the player at intervals corresponding to the elapsed time or number of spins since the last emergence of the mini-games or challenges. Via the system of the present invention, players are able to predictively earn rewards based on an overall gaming experience that keeps the player involved and engaged, lending to the popularity of the game.

### BRIEF DESCRIPTION OF THE DRAWINGS

The present invention will be better understood with reference to the appended drawing sheets, wherein:

FIG. 1 displays an example display of the screen detailing the profile of the present invention.

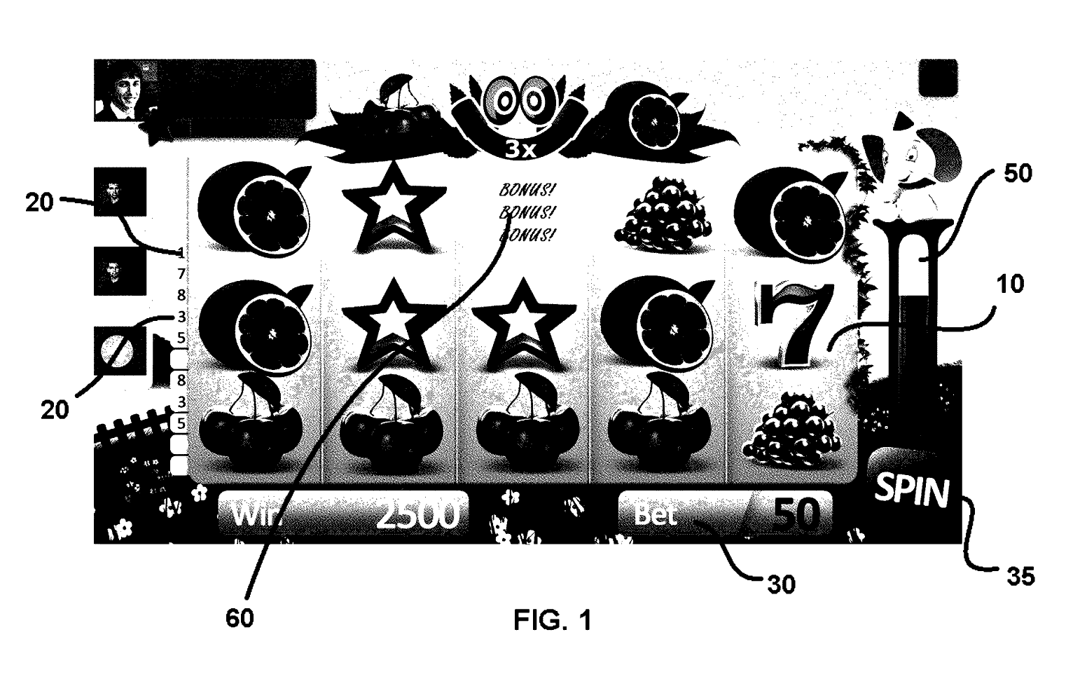

FIG. 2 shows a screenshot of the system of the present invention, detailing the lucky wheel.

FIG. 3 details a screenshot of the system of the present invention showing a player executing a base power of swapping two near or adjacent symbols.

FIG. 4 exhibits a screenshot of the system of the present invention showing a player executing the use of a special power of swapping any two reels.

FIG. 5 exhibits a screenshot of the system of the present invention showing a player executing the use of a special power of swapping any two symbols.

FIG. 6 exhibits a screenshot of the system of the present invention showing a player executing the use of a special power of scrolling a line (circular).

FIG. 7 exhibits a screenshot of the system of the present invention showing a player executing the use of a special power of respinning a reel.

FIG. 8 exhibits a screenshot of the system of the present invention showing a player executing the use of a special power of removing all symbols of a given type.

FIG. 9 exhibits a screenshot of the system of the present invention showing a player executing the use of a special power of removing a reel.

FIG. 10 exhibits a screenshot of the system of the present invention showing a player executing the use of a special power of moving and replacing any symbol.

FIG. 11 exhibits a screenshot of the system of the present invention showing a player executing the use of a special power of flipping the table.

FIG. 12 exhibits a screenshot of the system of the present invention showing a player executing the use of a special power of expanding a symbol (or replicating it across) a reel.

FIG. 13 exhibits a screenshot of the system of the present invention showing a player executing the use of a special power of destroying a line.

FIG. 14 exhibits a screenshot of the system of the present invention showing a player executing the use of a special power of cloning a symbol.

### DETAILED DESCRIPTION OF THE PREFERRED EMBODIMENT

The present invention is a new slot machine gaming method and system configured to yield more control of the game to the player, while providing additional interactivity between the machine and the player. The present invention is preferably equipped with at least one reel (10) having at least one pay line (20). The preferred embodiment of the present invention preferably employs digital reels (10) shown on a conventional touch screen display to facilitate the exchange of symbols on the at least one reel (10). Each of the symbols on the reels of the slot machine game of the present invention are dynamic, and may therefore be moved, swapped, exchanged, or destroyed according to the rules of the game, and the wishes of the player.

The system of the present invention embodies a slot machine game with a skill-twist that gives players the ability to partially take control over the table. The player is provided the option to move, swap, change or destroy a symbol or a set of symbols at certain intervals throughout gameplay. This ability, titled ‘Special Powers,’ is a unique twist on traditional slot machine play, as it is the first slot game equipped with this interactive element.

### 1. Special Powers

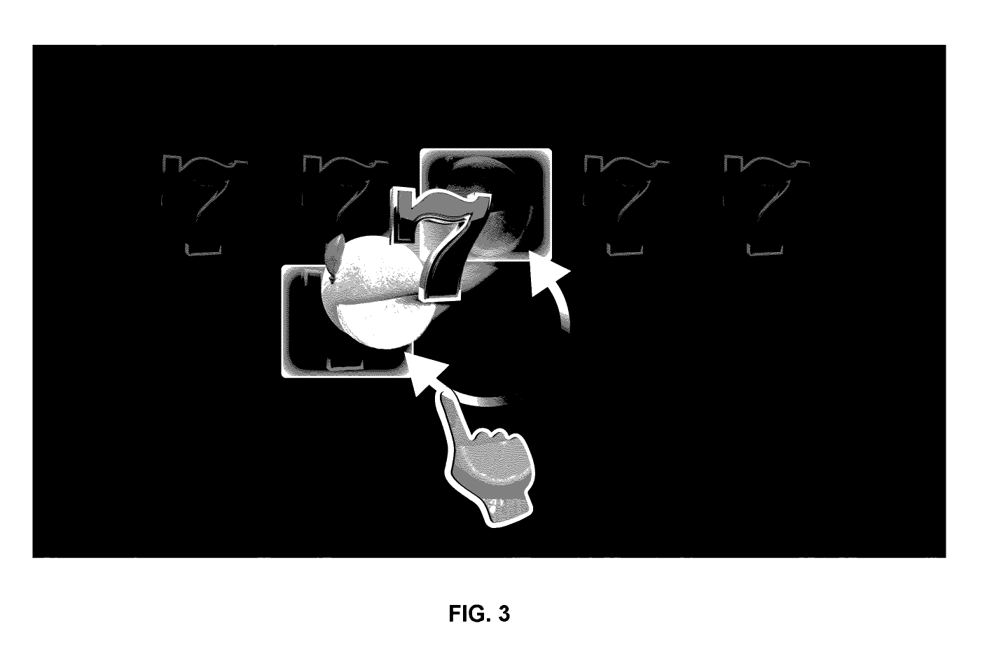

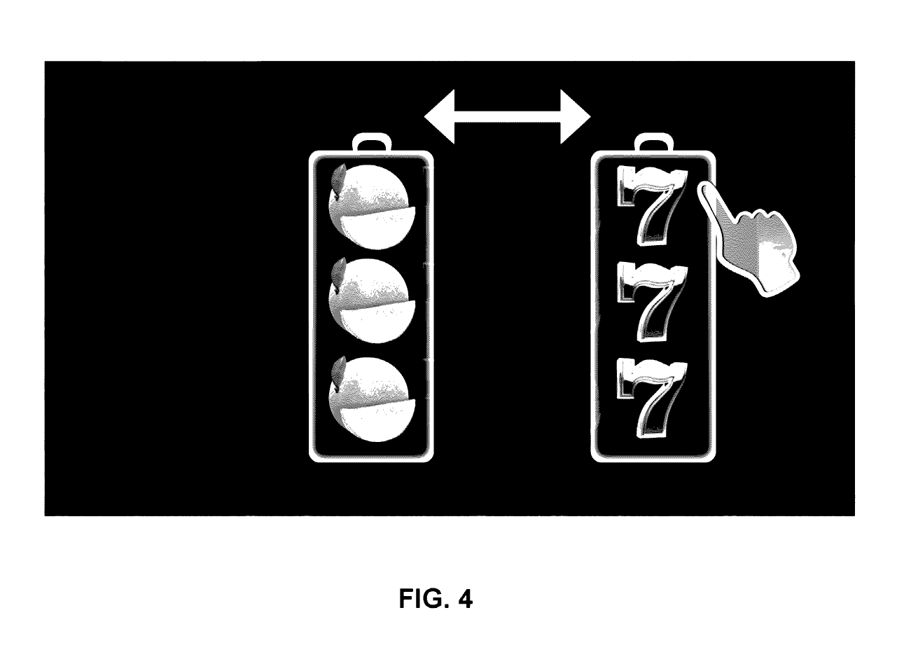

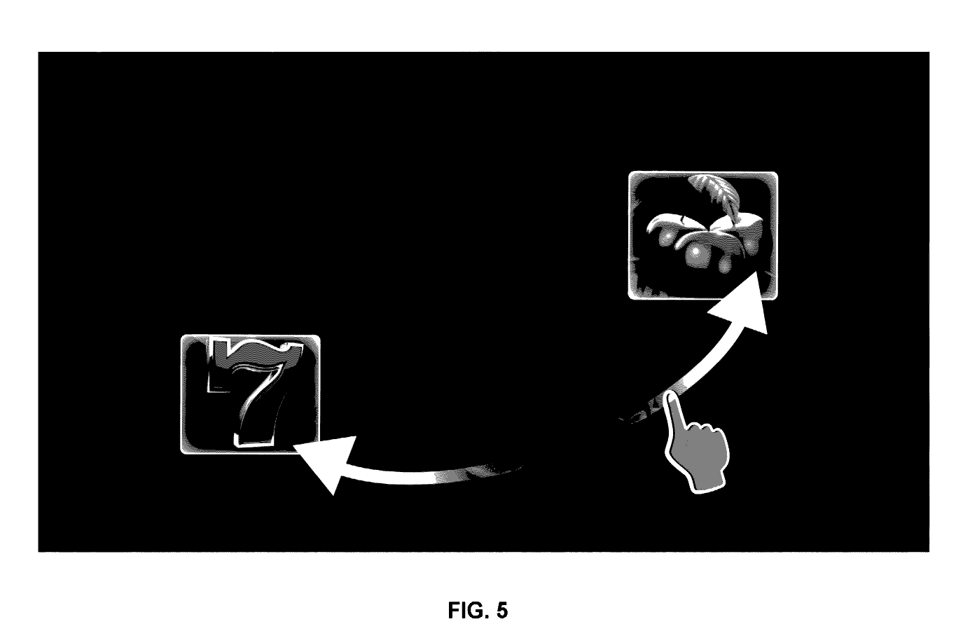

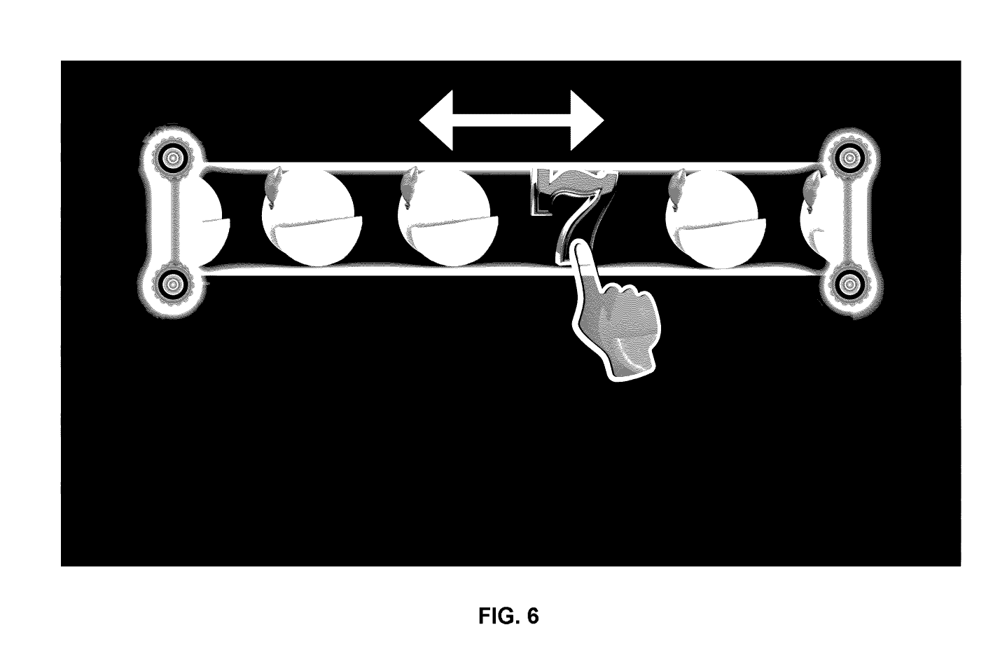

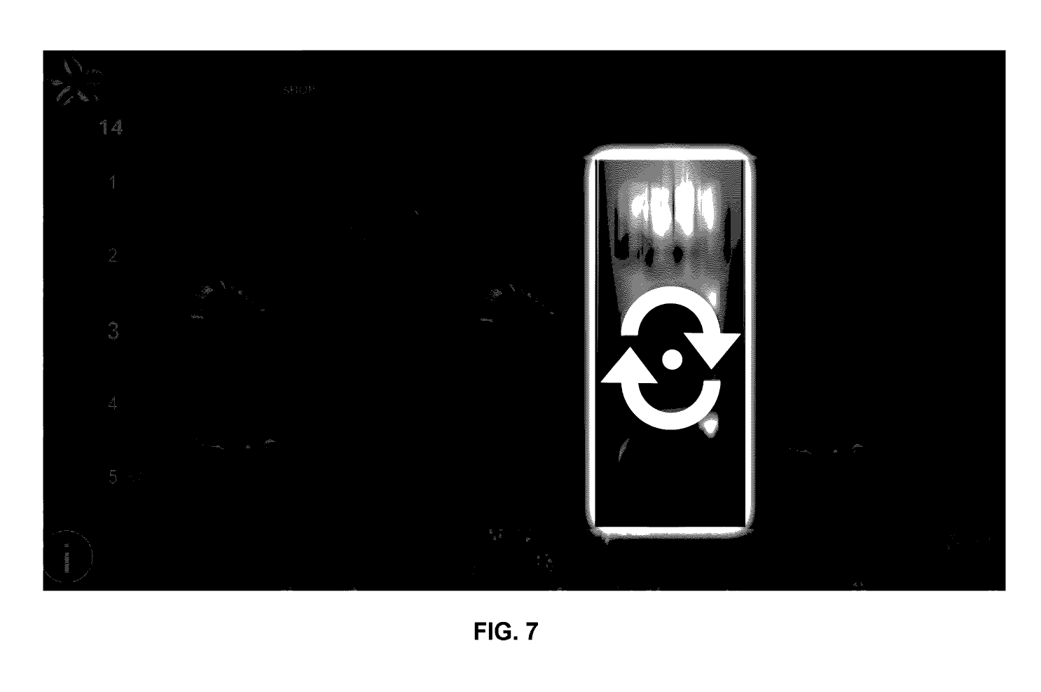

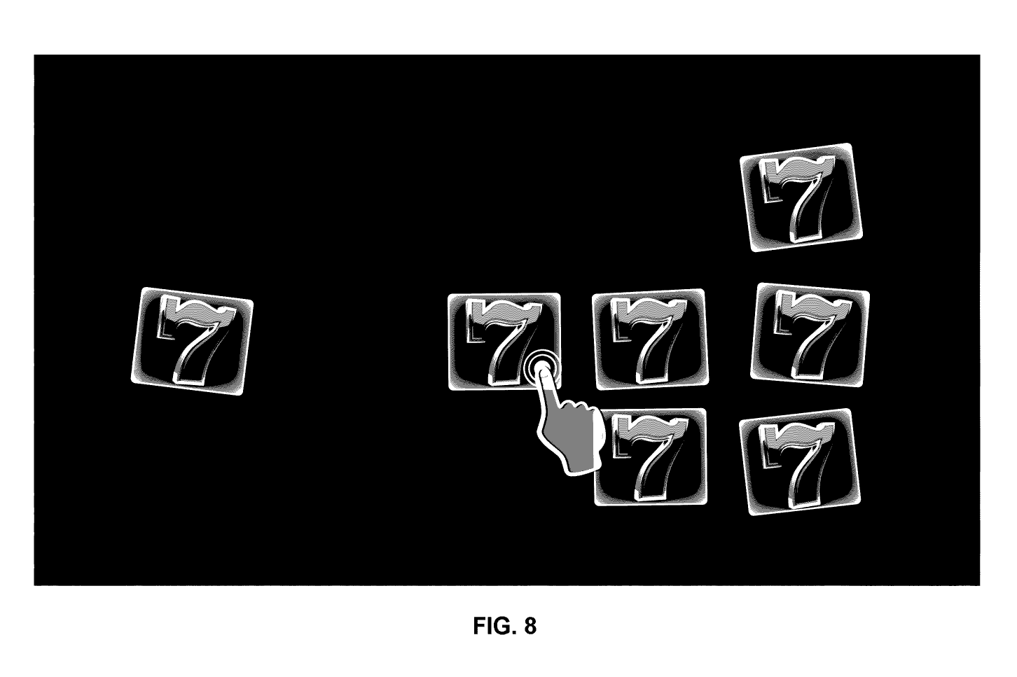

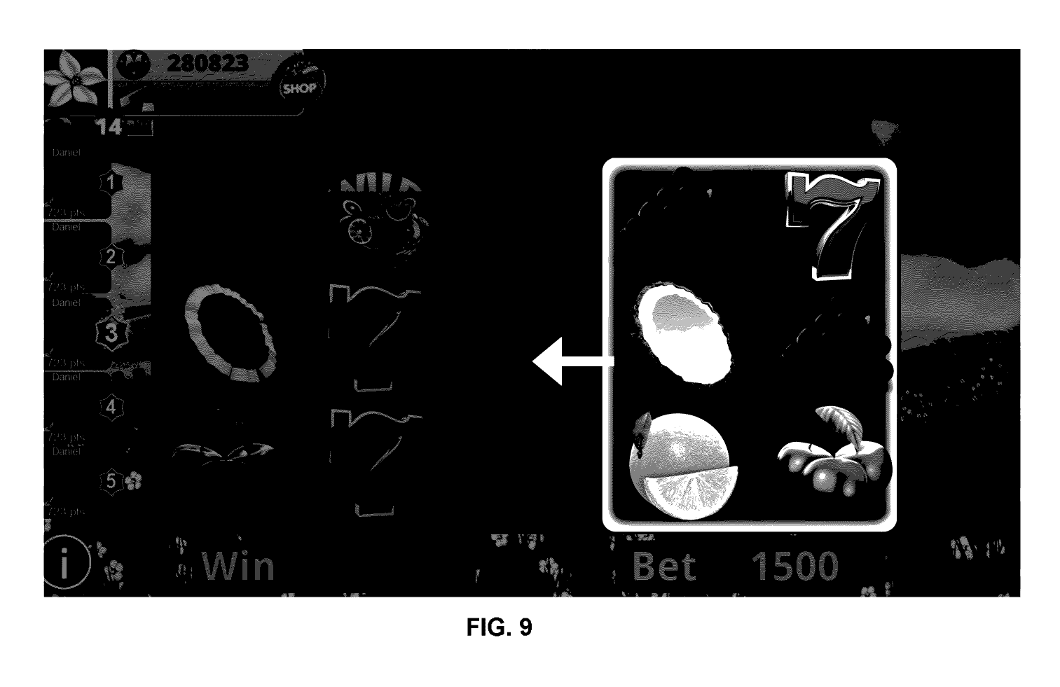

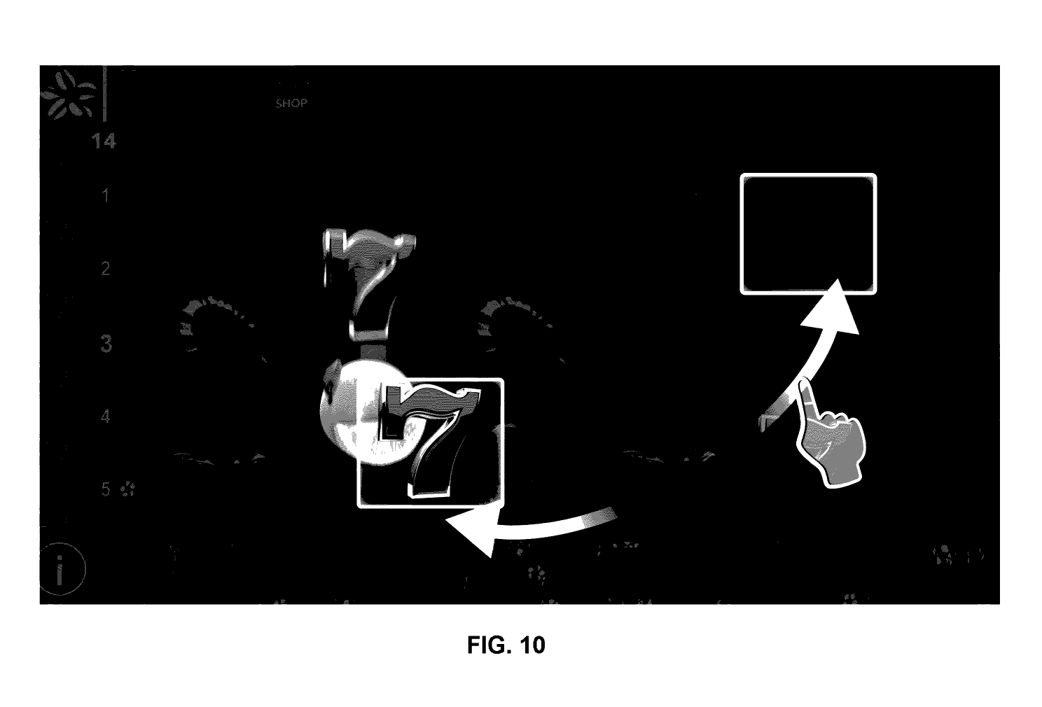

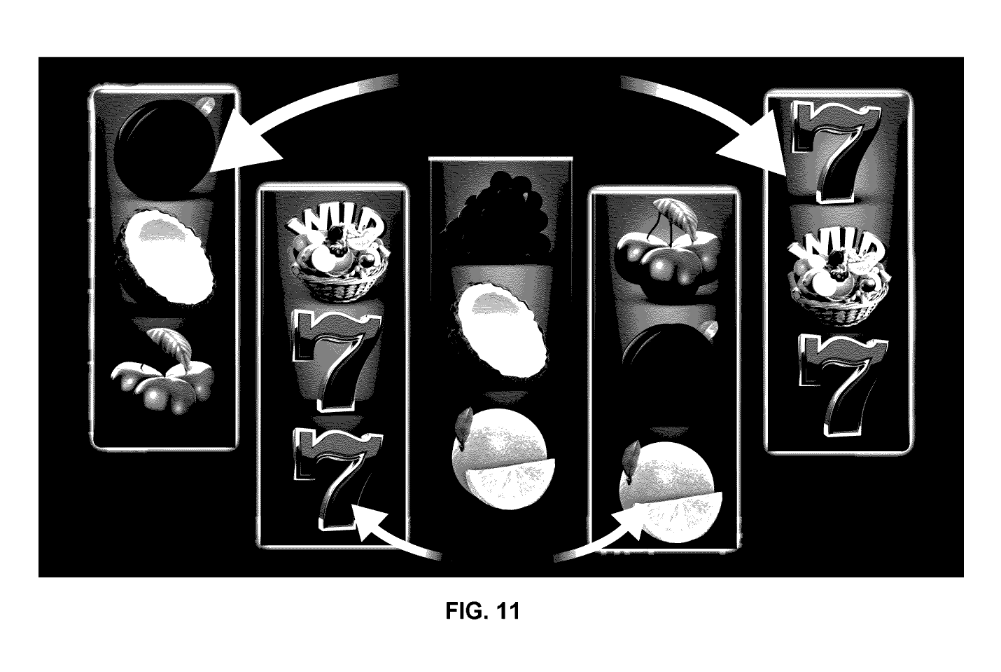

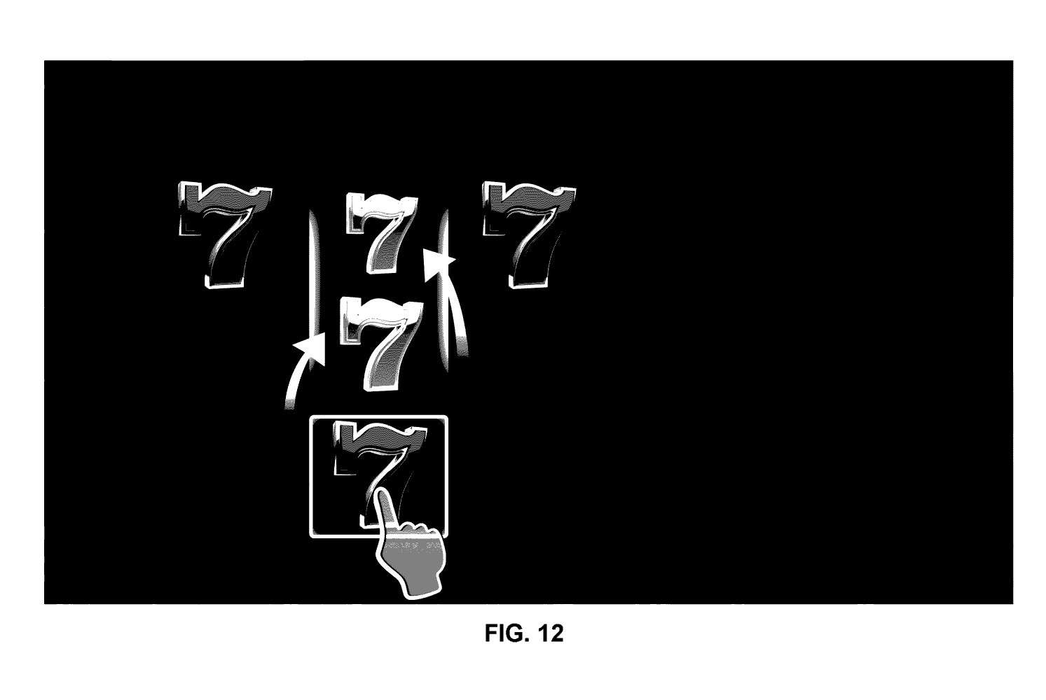

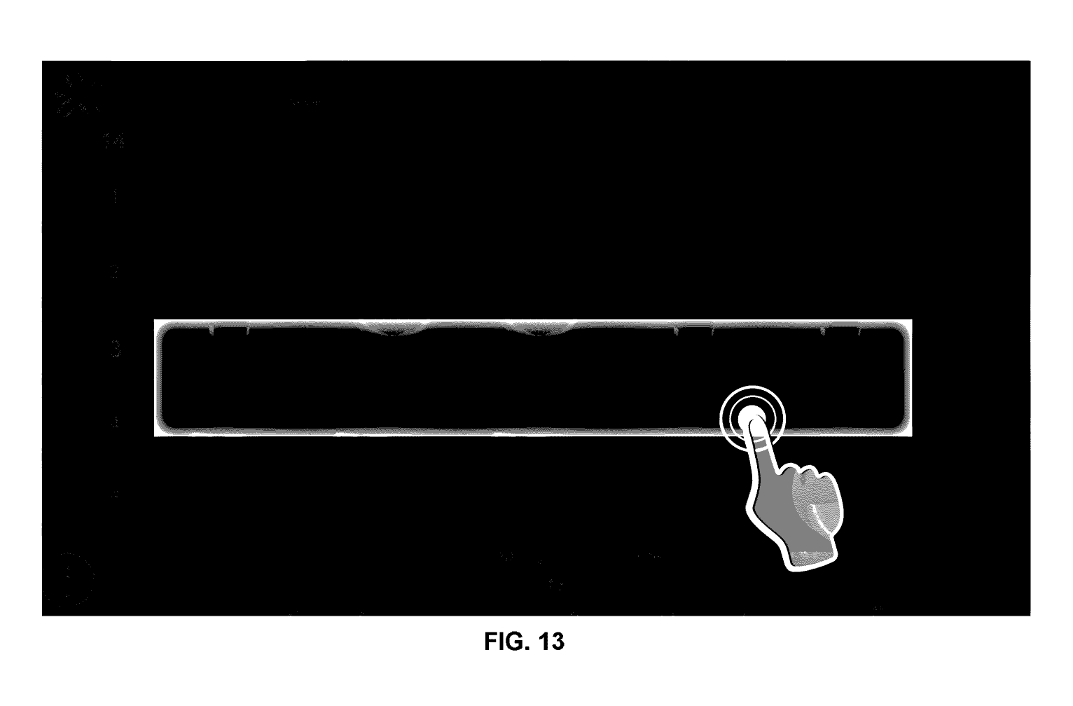

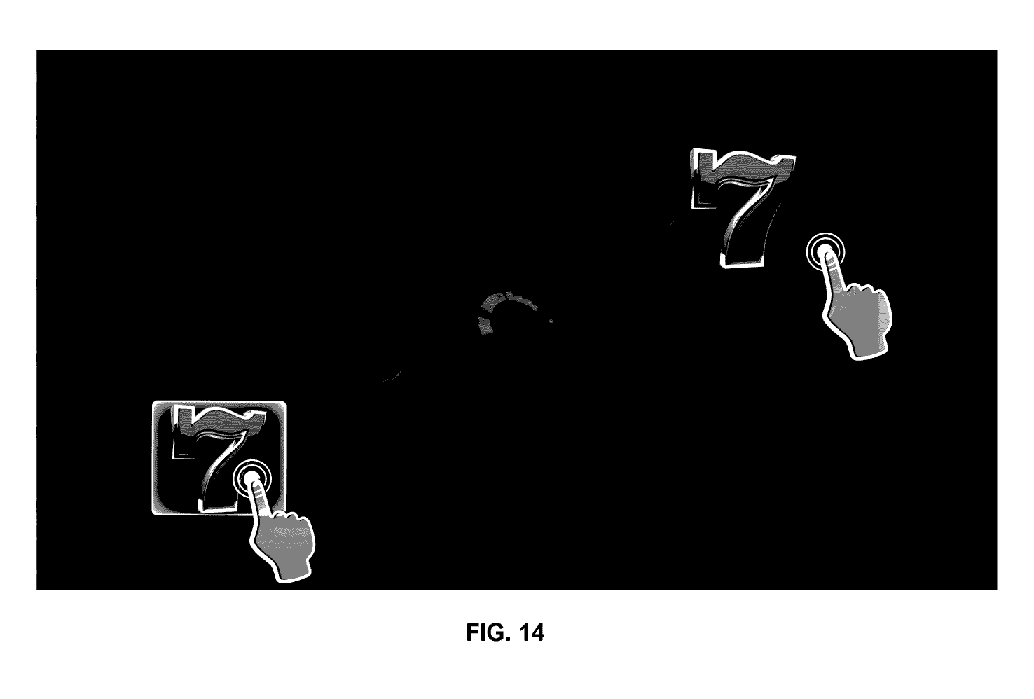

Interactive elements of the present invention are embodied via a basic Base Power and an assortment of Special Powers. The base power enables players to exchange neighboring symbols' placement. For example, the base power allows the player to exchange two adjacent symbols—vertical, horizontal or diagonal—such as in a conventional ‘match-three game.’ This ability can be used after every Spin, allowing the player to seemingly control the outcome of the game more directly. Each the Base Power and the Special power are preferably activated via on-screen contextually sensitive buttons. The special powers can be seen in use in FIGS. 4-14. The Base power is detailed in FIG. 3.

Yielding even more power to the player, the special power may be employed to yield an even greater outcome (in addition to use of the base power). The “Special power” allows the player to perform more complex actions including, but not limited to: destroy an entire row, regenerate a reel, or clone a symbol. Each Special Power preferably corresponds to a creature. Most embodiments of the present invention provide the player the option to use both the special power and the base power within a single spin.

Additionally, each Special power requires a resource to be used. The resource replenishment algorithm of the present invention depends on the power type, and can be: a number of spins, energy gained from winning lines, collecting a number of symbols of a certain type, or another set of conditions. It is envisioned that alternate embodiments of the present invention may be crafted to employ special resources corresponding to the establishment hosting the game system of the present invention.

During play, players can equip multiple companion powers at the same table and use them as necessary. The rules of the system of the present invention dictate that players can use both the Special Powers (Base power and special power) per Spin. Other embodiments of the present invention employ rules that dictate that only the base power or only the special power may be used within a single spin, but not both. Therefore, on each spin, players can interact with the symbols exchange two adjacent symbols—vertical, horizontal or diagonal and/or other special powers.

Traditional slot machines display the total amount won after each Spin. Conversely, the present invention differentiates between the traditional win (from winning lines that occur automatically after a Spin), and the bonus win (winning lines that occur after a Special Power is used). Each the traditional win amount and the bonus win amount are displayed separately as a clear differentiator from other Slots machine gaming systems. However, after special power execution, the win amounts are aggregated after each Spin to be displayed as the traditional “Last Win” amount.

### 2. Minigame

The system of the present invention is preferably equipped with at least one mini-game. Mini-games are configured to be presented to the player after a BONUS symbol (60) has appeared a number of times since the last mini-game activation. Each mini-game preferably requires a specific number of appearances which may be set by the hosting establishment, or are preferably established at the manufacturer. Additionally, Mimi-games may be triggered (or presented to the player) based on other conditions including: when three BONUS symbols (60) are displayed on the screen simultaneously, after 10 BONUS symbols (60) have appeared over the course of play or within X amount of time, when a Paying Symbol (with extra BONUS value) has appeared on the left-most reel such as a large “pirate captain” symbol filling the entire reel and initiating a “treasure Hunt” mini-game), and other trigger events. It should be understood that this list is not exhaustive.

Mini-games provide additional objectives for the player to pursue and complete using default slots mechanics in conjunction with the base power and the special power. The objective's completion can be binary (completed OR not completed), or may be configured to have degrees of completion (0% to 100%). Each mini-game of the system of the present invention preferably has an independent number of objectives. Objectives can be phased, and are activated once certain game conditions have been met; i.e. in a Maya eclipse-themed mini-game, the player gains “Domination” over the people for each winning line once the eclipse is at full (total eclipse). Domination is configured to preferably later translate into credits.

Player earnings are preferably tracked based on specific mini-game rules on top of earnings generated by the winning lines. As a result, players are rewarded to the user with all or a subset of game's economy currencies: “credits”, “gold bars”, “player XP (experience)” and/or “free spins”. The reward strength is determined by the completion percent of the objectives of the mini-game.

For example, a player could be tasked with using the touch screen to ‘mix a virtual cocktail’ by using some specific fruits; each fruit objective is completed when that fruit type is part of a winning line (according to slots winning pay line rules). Additionally, for each fruit of that type that makes an appearance on the table, the user is rewarded with 50 credits.

Mini-games of the present invention employ rules that do not rely on the standardized slots mechanics and/or our Special Powers feature, unlike conventional games such as maze runner, card guess, “Simon Says” and the like. The mini-games of the present invention are based on the core slots mechanics of spinning the reels coupled with the innovative mechanic of altering/influencing their outcome. The purpose of this style of mini-game gameplay is to provide gameplay variation for the duration of “mini-game active phase” to the player by altering the default reward value of certain actions. Therefore, the reward payout is dynamic in accordance with other aspects of the overall game. For example, the symbol “cherry,” which traditionally pays out the least, becomes a symbol of high-value during the mini-game phase of the present invention because the ‘cherry’ symbol contributes towards completing “the cocktail” as one of the ingredients that must be used in a winning line. Additionally, the cherry is configured to pay out a fixed number of credits for each instance it appears on the table (reels).

A new improvement to bonus mechanics is the “journey bonus feature” that progressively rewards the player for spending continuous time on the machine.

The traditional slots systems propose a fantasy, but they rarely create and enhance it through the gameplay features; i.e. a theme about hunting has symbols representing a hunter, a prey and maybe a weapon, but it does not take the player through the steps of the hunting process.

The present invention lets the player experience a ‘journey’ that supports the fantasy. The journey consists of at least two episodes that logically follow one after another; i.e. for the hunter theme, in episode-1 the player has to find clues to track the prey, while in episode-2 the player will effectively hunt it. Each episode is a mini-game with its own gameplay rules and awards and features a unique symbol, specific to that episode; in our present example, episode-1 features an “animal track” symbol and episode-2 features the “animal prey” itself. The early episodes start simple in terms of rules complexity and rewards and gradually grows to propose a more interesting scenario and challenge; also, each successive episode promises a higher earning chance i.e. when the “track” symbol appears on screen, all winnings are multiplied by ×2, while when the “animal prey” symbol appears on screen, all winnings are multiplied by ×3. All these mini-games take advantage and focus on interactivity following the proposed philosophy of the present invention.

For best rewards, it is supposed that the player completes the full cycle of episodes before changing the theme or cashing-out. Should the player want to leave while this cycle is in progress, the machine will ask for confirmation letting him know that the progress and the possible associated rewards will be lost.

### 3. Lucky Wheel

The system of the present invention is configured to present the player with an opportunity to win additional credits or points via a ‘Lucky Wheel’ (40). The Lucky Wheel (40) option is presented to the player once the mini-game phase has ended. The Lucky Wheel (40) is embodied by a roulette-like wheel that is spun by the user to win a random prize. The lucky wheel (40) may be either digitally displayed to the user, or may be a physical wheel embedded in the casing of the gaming machine of the present invention.

The lucky wheel (40) is configured to provide the user a chance to increase his minigame's earnings by some amount and/or gain additional rewards. Rewards awarded via the Lucky Wheel (40) include, but are not limited to: credits, gold bars, player XP, free spins. The Lucky Wheel (40) preferably appears to the user as a spinning-wheel that is roulette-like and is divided into slices of various sizes. Each slice of the Lucky Wheel (40) corresponds to a specific reward, and has its own chance to be selected. The probability of landing on each slice of the Lucky Wheel (40) is determined via the size of each slice. Based on how well the player has met the mini-game's objectives, some of the slices will have their reward improved.

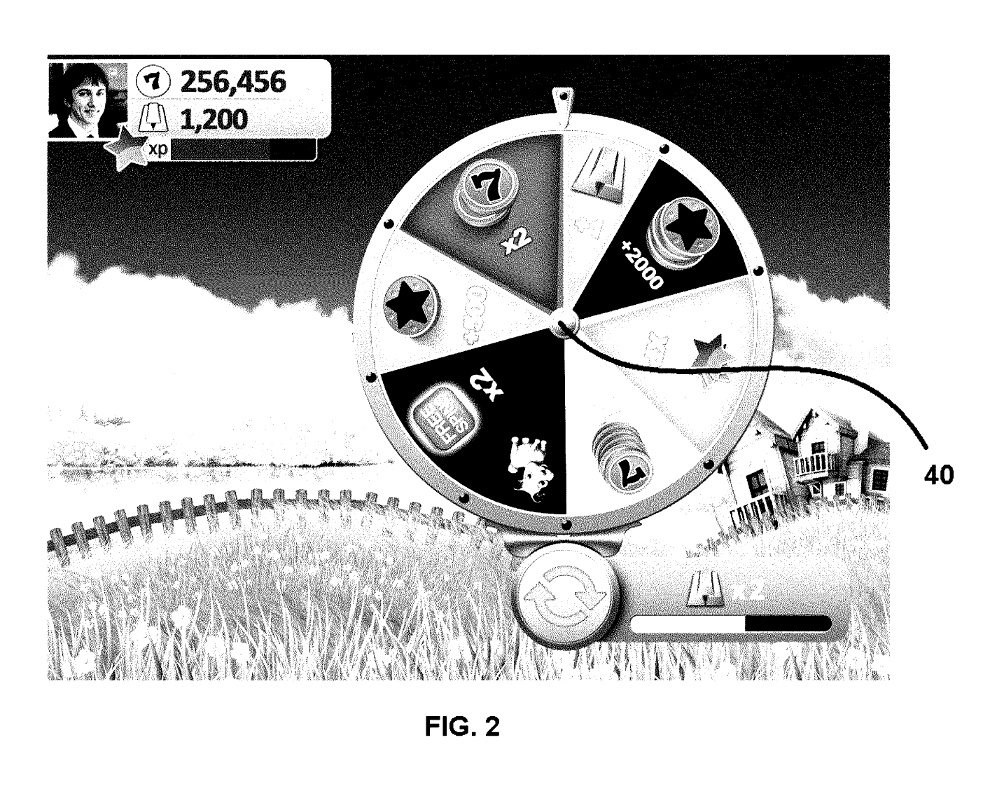

Each wheel spin costs a specified amount of resources, including zero. In the preferred embodiment of the present invention, the first spin of the Lucky Wheel (40) is free (costs nothing), while the subsequent spins of the Lucky Wheel (40) cost one, two, respectively three gold bars. The user cannot spin more than four times (free+paid once) in a row. The purpose of the Lucky Wheel (40) of the present invention is to incentivize the player to meet the objectives of the mini-games. The better the player performs in this regard, the richer the rewards options displayed on the spinning wheel that may be achieved. In this respect, the Lucky Wheel (40) of the present invention is configured to provide the player with a burst of gains, including but not limited to: multiplying the mini-game's earnings by a factor, player's XP as a fraction of current progress towards next player's level, gold bars or even the traditional slots' JACKPOT prize. The lucky wheel (40) can be seen in FIG. 2.

### 4. Bonus Objectives

Similarly, the gaming system of the present invention is configured to present the player with a variety of Bonus Objectives that arise scarcely throughout regular play at specific moments. Bonus Objectives are activated automatically without any user input. In the preferred embodiment of the present invention, a bonus objective never occurs during a mini-game.

Therefore, the Bonus Objective is canceled upon the activation of a mini-game. Bonus Objectives of the present invention are small, simple goals that, when achieved, rewards both Player XP and Credits to the player. It is envisioned that the Bonus Objective is active for a limited amount of Spins in direct relation with its difficulty. If this duration expires without meeting the goal requirements, the Bonus Objective ends without any reward to the player. An example of a goat for a Bonus Objective includes: If the player executes 10 winning lines within the limited time and/or spin number, the player is awarded with 500 credits. It should be understood that the Bonus Objectives of the present invention do not rely on other extraneous rules aside from the standard rules already employed by the present invention.

### 5. Boss Challenge

Additionally, the system of the present invention is equipped with a Boss Challenge feature (50) involving Boss Levels. Boss Levels are a specific challenge that alters game rules to a higher degree compared to regular objectives in order to provide a more “story-related” context and a more nuanced gameplay. Boss Levels are still played by the core slots rules—namely, spin & win based on some patterns. The challenge of the Boss Levels is limited to a number of spins in which you have to complete the required objectives. Each Boss Level Challenge of the Boss Challenge feature (50) preferably concludes with a WIN or a FAILURE. The present invention is configured to allow the player complete Boss Levels alone or with friends (play together at the same table). Joining to play with random people is preferably not allowed.

The Boss Challenge feature (50) is configured to occur during play as a blocking challenge objective which the player must defeat in order to pass. The Boss Challenge feature (50) is ideally presented to the player after every five tables or turns. Some embodiments of the present invention employ the Boss Challenge feature (50) of the present invention as a daily free challenge with rich rewards to be dealt to successful winning players.

The Boss Challenge feature (50) is preferably enacted as regular table play with select restrictions. Restrictions to the Boss Challenge feature (50) differentiating it from other gameplay include:
The Boss Challenge feature (50) is configured to only last a predefined number of spins (around 20-30).
all spins are FREE.
the goal of the Boss Challenge feature (50) is to earn a certain amount of credits.
Minigame and Special Objectives do not apply during this game mode.
SCATTER and BONUS symbols do not occur during this game mode.
The player must pay gold bars each time the player enters the challenge. Once the player has beaten the challenge, he or she can no longer play it; but, the specific challenge of the boss challenge feature (50) will sometimes appear as a “free daily challenge.”
   The Boss Challenge feature (50) is preferably played in the following fashion:
The ‘Boss’ will “steal” some coins every spin that earns nothing or otherwise (either through normal win or bonus win). Additionally, the Boss steals from credits earned during the current game, not the total bank roll; the amount cannot go below zero.
Some table cells are “chained”; you need to make a winning line with the symbol below in order to remove chains, but that winning line will not reward any credit.
The Boss will sometime “re-chain” some cells;
Power-ups may occur as modifiers for symbols (such as “Unchain all” or “Extra credits”). In order to collect a power-up, the player must include the power-up symbol in a winning line.

Generally, the role of the Boss challenge feature (50) of the present invention, with respect to the story of the overall game, is to advance the story, and to provide a much more “game level” user experience than the traditional “endless” slots environment. The user selects the level, an objective is given, and the user has a limited amount of moves to complete the objective.

With regard to the story of the gameplay elements of the present invention, the objective of the boss challenge feature (50) may be anything, as long as it makes sense in the given context of the story. While highly desirable, it is not required to play against a virtual opponent that will act like a villain. i.e. for a pirate-themed table, the player will be asked to sink the nefarious “Flying Dutchman” by performing bonus wins(using Special Powers) while dealing with “chained” symbols (free them from the undead grasp). In another scenario, the player will help Thirsty Moe win an empty rum-bottles recycling contest by collecting “Rum Bottle Symbols”.

### 6. Social Objectives

Like many games, the gaming system of the present invention is more fun for players to play when it is played with other people. While sitting and playing at a table with up to four other persons, the players must combine efforts together, or compete against each other for the grand prize. The players are tasked with the objective of reaching a simple goal within two to three minutes.

There should be at least one player in the game room in order for a new objective to arise; for competitive objectives, this minimum limit is 3. Similarly, for competitive play, additional rules should be enforced:
If there are two or fewer players in the game room, and an objective is presently in progress, then it will be put on hold; the on-hold timer is set to equal the time remaining to objective completion.
If the minimum player number requirement has been met, the objective is resumed from where it was put on hold (same progress, same time remaining).
If the on-hold timer expires, all players in the game room will receive rewards proportional to their time present on the table when the objective was active.

### Cooperative Play

During the cooperative objective portion of the gaming system of the present invention, players play together to win against the house. When the cooperative objective ends, everyone who contributed will get a reward, directly proportional with their respective activity time. Players who contributed for the entire duration of the objective receive 20% more rewards than other players. Each player must be present in the room when the objective ends to receive any reward. Rewards provided to players are preferably awarded as credits and XP.

### Competitive Play

If a player likes competitive play, the player may opt-in to sit in rooms where a competitive objective is prone (programmed) to occur. Competitive-enabled rooms will alternate between the two social objectives types.

The full prize is taken only by the winner, which is preferably awarded as credits and XP. All other players only receive a fraction of the winner's XP prize. Each player must be present in the room When the objective ends to receive any reward.

### Tournaments

When embodiments of the present invention are deployed, there is always at least one tournament active. The tournament is a competitive form of social play of the gaming system of the present invention, and provides a fun incentive to experience a new table, or a positive frustration to purchase one. Tournaments allow players to play where the money is, as well as where their friends play. A tournament preferably only runs for a limited time, on average 10 to 30 minutes. A limited set of tables may qualify for a tournament. Once a player has played a SPIN at one of these tables, the player is automatically enlisted as participant.

### 7. Other Features

The following are features of the gameplay of the preferred embodiment of the present invention, which include those element of the Special Powers, Mini-games, and other features denoted above, as well as conventional industry terminology.

Row Refresh: Changes the symbols from a line with others randomly selected by the present invention.

Row Circular move (free amount): The player moves all the symbols from a row to the left or right like in a circular row. The first symbols from the left when moved to the left will appear on the right of the screen, and the other way around for the last symbols from the right.

Reel—Switch sides: The player is provided the option to switch a reel with any other reel. For instance, reel one can be exchanged with reel five, and/or reel two may be exchanged with reel four.

Reel—Move and insert: A reel can be moved by the player (and may be inserted by the player) in any other reel location.

Card—Switch places free: The player is provided the option to switch any two symbols' position at will.

Teleport Card: Moves a symbol to another position, replacing the destination symbol. At the original position of the moved symbol, a new symbol is randomly regenerated by the computer of the gaming machine.

Card—Clone Target: The player may select a symbol he or she wishes to clone. Then the player may select the location he or she wishes to clone the symbol on the reels.

Reel—Switch Places Free: The player is provided the option to switch the position of two any reels.

Reel—Spin: New symbols are randomly generated on that reel for initial play.

Card type—replacement: Select all the identical symbols, which are then replaced with other symbols that are preferably randomly generated by the internal computer of the machine.

Reel—Destroy: The user is instructed to select a reel. The selected reel is then destroyed and the other reels will move in from right to left to fill in the void left from the destroyed reel.

Reel—Expand: The player is provided the option to select a symbol, whereby upon selection, the remaining symbols of the reel take the nature of the selected symbol.

Row—Symbol Select Destroy: With this feature, a player may destroy symbols from a row; the above symbols will fall on the destroyed row and the first row will have randomly generated symbols.

Place Symbol: Generates a symbol that is not shown on the table in the moment of activation; you can place the symbol anywhere on the table. The symbol “expires” after three spins.

Block Reels: Blocks up to three reels of the spin. When activated, the selected reels will not spin on the next spin. Each cool-down charges a “use charge” and maximum of three spins.

Block Symbols: Blocks up to three symbols; the special symbols (wild, bonus, scatter) can't be blocked. Each cool-down charges a “use charge” and maximum three.

Reel—Reverse: reverse symbols on a reel: the first symbol on the reel will be switched with the third.

Card—Roulette fixed position: All the symbols are rotated around a central symbol (with only one position—the rows become columns and vice versa).

Reel—re-arrange cards: The player is provided the option to re-arrange the positions of the symbols on a selected reel in a random manner.

Card—regenerate random: A symbol is selected by the player, and the symbol is then replaced with another symbol that is randomly generated by the present invention.

Card—Roulette random: All the symbols are rotated around a central symbol (with a random number of positions rotated).

Reel—Switch Places: The player is provided the option to switch between two touching reels.

Reel—vertical: Circular roll on a reel. The reel moves vertically with n positions rotated.

Row—circular move (one position): When provided, the player may move all the symbols from a row to the left or to the right, as in a circular row, just one position at the option of the player. The first symbols from the left of the row, when moved to the left of the row, will appear on the right of the screen, and the other way around for the last symbols from the right.

Alternate embodiments of the present invention may include variations on the number and size of the reels, the size of the display screen, the symbols employed, and the probabilities for payouts, mini games, and special symbols.

### 8. On-the-House Free Spins

Free Spins are spins granted for free to encourage players to sit-down & play at a Machine. Every machine featuring the present invention that has been inactive for a while will display 2-5 floating free spins as ready to be unlocked.

Free Spins are preferably not awarded immediately after someone starts playing, but once a certain condition has been met. Free Spins are guaranteed to be awarded within the first 50 (value used for example purposes only) spins. To prevent exploits, these floating free spins will be played using the average Bet Value played within the gaming session.

### 9. Community Jackpot

All players' actions tor unlocking a jackpot; everyone who participated into it and is currently actively playing will get a share of the community jackpot based each player's personal contribution.

### 10. Integrated Customer Loyalty System

Every player that participates in the network of presented game systems exhibiting the present invention earns progress towards a loyalty rewards scheme. Progress towards the loyalty rewards is preferably earned by simply playing the game, but visible advancement can be made by fulfilling daily objectives. Daily objectives are simple goals such as, “Play 300 SPINS” or “Complete two mini-games” that, when completed, award a large amount of loyalty points to the player.

The loyalty system rewards consist either in boosting the players' earnings through a direct or indirect way, or providing more control/skill room in game mechanics. Rewards can unlock more floating spins, are able to extend the length of bonus features with extra spins, enable the player to participate in limited-access tournaments, or simply provide a higher chance to win a jackpot.

11. Gameplay Highlights/Showcase when Game is Available

A machine that is not occupied by a player should showcase its most impressive game sequences on a regular basis. This behavior is successfully used by arcade machines, but not slot machines (yet). It makes sense for use with the present invention, as gaming machines equipped with the system and method of the present invention introduce the skill differentiator to players, which can appeal to players' imagination and anticipation by presenting outcomes of great wins, or display the mini-game mechanics of the present invention in action.

### 12. Heads-Up Challenge

Highly-competitive players will make a bet and engage one-vs-one in this adrenaline-high feature of the present invention. One player will post his availability and bet size, and other players in the network (sharing the same interest) will be notified. Once a challenger has accepted the deal, both of them will play identical reels in a mini-tournament; only skill and inspiration will decide the winner, who will take the entirety of the prize.

During this mini-tournament, the spin bet will not be deducted from the player's bankroll. Instead, both players will compete for points for a limited number of spins, focusing only on the decisions and actions they have to make. Players will have enough “tools” and randomness factor to create room for dramatic change of events: swapping symbols, rechargeable super-powers that affect the table and the rate at which they earn points and the inspiration when and Where to use these scarce resources.

It should be understood that the special powers of the present invention involve all interactive mechanics that are more complex than the Base Move (base power). The base power is the ability to swap two nearby symbols. As such, special powers preferably include swapping two reels, destroying a line of symbols, re-spinning a reel, cloning a symbol, and others listed above. Additionally, it should be understood that the system of the present invention may implement and execute any of these special powers in accordance with a variable means of delivery to the player, including, but not limited to delivering the special power to the player as an animal companion, an abstract button or themed game condition (specific to the machine, such as the presence of a specific symbol on screen), or similar mechanic, each of which containing the functionality of interacting and/or influencing the outcome of a spin within the system of the present invention.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

We claim:

1. A dynamic interactive reward gaming method comprising:
a player approaching a gaming machine;
the player spinning at least one reel;
wherein the at least one reel displays dynamic symbols;
symbols of the at least one reel changing at a high frequency beyond human perception;
wherein the symbols are dynamic;
a computer of the gaming machine;
the at least one reel stopping spinning, showing a line of symbols across a payline;
the player selecting at least one symbol of the line of symbols;
the player activating a base power, moving the at least one symbol to a different location on the board by selecting a desired new location on the board, potentiating a winning payline;
the computer assigning at least one card to the player, the at least one card containing one or more of the following variations: a switch card, a teleport card, a clone target card,
the computer awarding a special power to the player according to a replenishment algorithm, the special power being one of the following: destroying an entire row of the at least one reel, regenerating a reel of the at least one reel, removing a reel of the at least one reel, respinning a reel of the at least one reel, swapping any two symbols, and cloning a symbol displayed on the table;
wherein use of the special power requires use of a resource;
the computer awarding resources to the player, resources generated by the computer according to one of the following: a number of spins has passed, sufficient energy has been gained from winning lines, and a specified number of symbols of a specified type are collected;
the player earning sufficient resources to employ a special power;
the player using the resources to use a specific special power;
the computer interpreting the use of the special power;
the computer altering the placement of the symbols on the table according to parameters of the special power used; and
the computer allotting winnings to the player.

2. The method of claim 1, further comprising:
the computer providing a mini-game to the player upon the player matching corresponding mini-game symbols on the at least one payline; and
wherein the mini-game is theme-specific.

3. The method of claim 1, further comprising:
the computer providing a lucky-wheel mini-game to the player;
wherein the lucky-wheel contains pie-slice-shaped pieces corresponding to awards;
the player spinning the lucky-wheel; and
the computer of the gaming machine enacting the result of the spin of the lucky-wheel.
